(19) United States
(12) Patent Application Publication
(10) Pub. No.: US 2007/0091183 A1
(43) Pub. Date: Apr. 26, 2007

(54) Method and apparatus for adapting the operation of a remote viewing device to correct optical misalignment

(75) Inventors: Clark Alexander Bendall, Syracuse, NY (US); Thomas William Karpen, Skaneateles, NY (US); Jon R. Salvati, Skaneateles, NY (US)

Correspondence Address: MARJAMA & BILINSKI LLP, 250 SOUTH CLINTON STREET, SUITE 300, SYRACUSE, NY, 13202, US

(73) Assignee: GE Inspection Technologies, LP, Schenectady, NY (US)

(21) Appl. No.: 11/582,900

(22) Filed: Oct. 18, 2006

Related U.S. Application Data
(60) Provisional application No. 60/729,153, filed on Oct. 21, 2005.

(51) Int. Cl. H04N 5/232

(52) U.S. Cl. 348/211.99

(57) ABSTRACT

Methods and apparatus are provided for adapting the operation of a remote viewing device to compensate for at least one potentially misaligned optical lens by identifying, within a pixel matrix, one or more optical defects that are suggestive of one or more misaligned optical lenses and, in response, adjusting the position of an active display area in order to seek to correct the optical misalignment.

### CROSS-REFERENCE TO RELATED APPLICATION(S)

This application claims priority from, and incorporates by reference the entirety of, U.S. Provisional Patent Application Ser. No. 60/729,153. It also includes subject matter that is related to U.S. Pat. No. 5,373,317, from which priority is not claimed, but which also is incorporated by reference in its entirety herein.

### FIELD OF THE INVENTION

This invention relates generally to the operation of a remote viewing device, and, in particular, to methods and apparatus for adapting the operation of a remote viewing device in order to correct or compensate for optical misalignment, such as between an imager and at least one lens of the remote viewing device.

### BACKGROUND OF THE INVENTION

A remote viewing device, such as an endoscope or a borescope, often is characterized as having an elongated and flexible insertion tube or probe with a viewing head assembly at its forward (i.e., distal) end, and a control section at its rear (i.e., proximal) end. The viewing head assembly includes an optical tip and an imager. At least one lens is spaced apart from, but is positioned relative to (e.g., axially aligned with) the imager.

An endoscope generally is used for remotely viewing the interior portions of a body cavity, such as for the purpose of medical diagnosis or treatment, whereas a borescope generally is used for remotely viewing interior portions of industrial equipment, such as for inspection purposes. An industrial video endoscope is a device that has articulation cabling and image capture components and is used, e.g., to inspect industrial equipment.

During use of a remote viewing device, image information is communicated from its viewing head assembly, through its insertion tube, and to its control section. In particular, light external to the viewing head assembly passes through the optical tip and into the imager via the at least one lens. Image information is read from the imager, processed, and output to a video monitor for viewing by an operator. Typically, the insertion tube is 5 to 100 feet in length and approximately ⅙ to ½″ in diameter; however, tubes of other lengths and diameters are possible depending upon the application of the remote viewing device.

The manufacture of an imager and its associated lens(es) is difficult and exacting, due at least in part to the small sizes and tolerances involved. These and other factors can lead to the imager and its associated lens(es) being axially misaligned as manufactured. This is problematic because a misaligned lens can interfere with the correct operation of the imager and, in turn, of the remote viewing device as well. For example, a misaligned lens can cause obstruction of light that otherwise would be accessible to, and thus viewable by, an imager. Also, a misaligned lens can result in the imager transmitting visual images, which, when viewed, appear as optical defects such as dark, blurred and/or glared areas, particularly in the corners or along the edges of the image. Moreover, for stereoscopic remote viewing devices, a misaligned lens can cause one of the produced stereo images to appear smaller than the other, among other problems.

Unfortunately, during the manufacturing process it is difficult to perfectly align the imager and lens(es) of a remote viewing device. Often, however, the existence of a misaligned lens is not discovered until after curing of the epoxies or glues that are used to hold the viewing head assembly together. And once that has occurred, the way most opt to deal with a misaligned lens problem is to repair or scrap (i.e., dispose of) the imager and its associated lens(es). Such approaches are not ideal, however, since they are costly and time consuming and the repaired/replaced parts still might suffer from the same problem.

Another option is to attempt to correct the misaligned lens(es) problem. One exemplary misalignment correction technique is described in U.S. Pat. No. 6,933,977 (“the '977 patent”), the entirety of which is incorporated by reference herein. The '977 patent calls for altering the relative timing between a synchronization signal(s) and an image signal outputted from an imager. This correction technique is similar to sync pulse shifting, which has been used for displaying television broadcast signals on CRT television tubes. Both the techniques described in the '977 patent and the sync pulse shift technique in general are problematic in that they provide limited flexibility for defining the size and location of the displayed image relative to the sensed/broadcasted image. Other misalignment correction techniques are flawed in similar and/or other ways such that, at present, lens misalignment correction is not a better alternative to repairing or scrapping the affected lens(es).

Thus, a need exists for a technique to correct one or more misaligned lenses of a remote viewing device whereby the correction technique is suitably reliable and easy to implement without being unduly time consuming or expensive.

### SUMMARY OF THE INVENTION

These and other needs are met by methods and apparatus for adapting the operation of a remote viewing device to correct optical misalignment. In an exemplary aspect, a method for adapting the operation of an imaging system of a remote viewing device to correct optical misalignment comprises the steps of (a) providing an imaging system that comprises (1) an imager that includes a pixel matrix that has a plurality of pixels, wherein a subset of the plurality of pixels corresponds to an active display area of the pixel matrix, and wherein the active display area has a center location, and (2) at least one lens through which a field of light passes to form at least one illumination area that overlaps at least a portion of the plurality of pixels, (b) identifying the presence of at least one optical defect (e.g., one or more of at least one dark region within the pixel matrix, at least one glare region within the pixel matrix, and at least one blurred region with the pixel matrix, incorrect positioning of a target) that is suggestive of optical misalignment; and (c) repositioning the active display area within the plurality of pixels in response to the presence of the at least one optical defect.

In accordance with this, and, if desired, other exemplary aspects, the field of light that passes through the at least one lens has been reflected off a target (e.g., a grid), wherein the target includes a reference item (e.g., a grid image) that has a predetermined positional relationship with respect to the imaging system. Also, the pixels within the active display area can be displayed on a display monitor. Additionally, the repositioning step of the exemplary method can be performed by an operator providing input to the imaging system and/or the identifying step can be performed via pattern recognition software whereby output from the pattern recognition software is used to perform the repositioning step.

Moreover, this, and, if desired, other exemplary methods, can further comprise the steps of providing a grid that is configured to reflect light that forms a grid image having a center location; capturing at least a portion of the grid image within the pixel matrix; and confirming that the center location of the grid image is offset from the center location of the active display area. Thus, the repositioning step can be effective to reduce the offset between the center location of the grid image and the center location of the at least one illumination area to an extent whereby the center location of the grid image is at least substantially proximate the center location of the active display area.

Also in accordance with this, and, if desired, other exemplary aspects, the field of light can form two illumination areas, each formed by a separate field of light passing through the at least one lens. The illumination areas can be overlapping or non-overlapping.

If the two illumination areas are overlapping, they form an overlap region, and in accordance with a related aspect of the exemplary method, the method can comprise the further steps of identifying a center location of the overlap region and confirming that the center location of the overlap region is offset from the center location of the active display area. Thus, the repositioning step is effective to reduce the offset between the center location of the overlap region and the center location of the active display area to an extent whereby the center location of the overlap region is at least substantially proximate the center location of the active display area.

In accordance with another exemplary method for adapting the operation of an imaging system of a remote viewing device to compensate for optical misalignment, the method comprises the steps of (a) providing an imaging system that comprises (1) an imager that includes a pixel matrix that has a plurality of pixels, wherein a subset of the plurality of pixels corresponds to an active display area of the pixel matrix, and wherein the active display area has a center location, and (2) at least one lens through which a field of light passes to form at least one illumination area that overlaps at least a portion of the plurality of pixels, (b) confirming that at least a portion of the active display area lies outside of the perimeter of the at least one illumination area; and (c) repositioning the active display area such that the repositioned active display area lies at least substantially entirely within the at least one illumination area.

In accordance with still another exemplary method for adapting the operation of an imaging system of a remote viewing device to compensate for optical misalignment, the method comprises the steps of (a) providing an imaging system that has an optical axis and that comprises (1) an imager that includes a pixel matrix that has a plurality of pixels, wherein a subset of the plurality of pixels corresponds to an active display area of the pixel matrix, and (2) at least one lens, (b) providing a target (e.g., a grid) that has a predetermined position with respect to the optical axis, (c) passing light through the at least one lens to produce an image of the target on the imager, (d) identifying at least one reference location on the target image, (e) determining that the at least one reference location is offset from a predetermined location within the active display area, (f) repositioning the active display area such that the predetermined location is substantially proximate the at least one reference location.

In accordance with an exemplary imaging system that is adapted to a correct optical misalignment between at least one optical lens and an imager of a remote viewing device, the imaging system comprises (a) a pixel matrix on the imaging device, wherein the pixel matrix includes a plurality of pixels, a first subset of which corresponds to an active display area that has a center location, and wherein the pixel matrix further includes at least one illumination area that has a perimeter and that is formed by a field of light passing through the at least one optical lens, and wherein the at least one illumination area overlaps at least a portion of the plurality of pixels, and (b) an aligner that is adapted to reposition the location of the active display area in response to the presence of at least one optical characteristic (e.g., the presence of at least one optical defect suggestive of optical misalignment, or the difference between an actual position of a pattern and a predetermined position of the pattern, wherein the difference is large enough to be suggestive of optical misalignment). Such repositioning of the active display area can entail, if desired, the active display area being located outside of the perimeter of the at least one illumination area prior to being repositioned and substantially entirely within the perimeter of the at least one illumination area after being repositioned.

In accordance with an exemplary remote viewing device that is configured to be electronically adapted to correct optical misalignment, the remote viewing device comprises (a) an insertion tube that has a distal end and that includes a viewing head assembly, wherein the viewing head assembly includes an imaging system comprising (1) an imager including a pixel matrix that has a plurality of pixels, wherein a subset of the plurality of pixels corresponds to an active display area of the pixel matrix, and wherein the active display area has a center location, and (2) at least one lens through which a field of light passes to form at least one illumination area that overlaps at least a portion of the plurality of pixels, (b) a digital signal processor that is adapted to process a communicated image represented by the pixel matrix, wherein the communicated image includes at least one optical defect suggestive of optical misalignment, and (c) an aligner that is adapted to communicate with and direct the digital signal processor so as to reposition the active display area in response to the presence of the at least one optical defect.

Still other aspect and embodiments, and the advantages thereof, are discussed in detail below. Moreover, it is to be understood that both the foregoing general description and the following detailed description are merely illustrative examples, and are intended to provide an overview or framework for understanding the nature and character of the invention as it is claimed. The accompanying drawings are included to provide a further understanding of the various embodiments described herein, and are incorporated in and constitute a part of this specification.

### BRIEF DESCRIPTION OF THE DRAWINGS

For a further understanding of these and objects of the invention, reference will be made to the following detailed description of the invention which is to be read in connection with the accompanying drawing, wherein:

FIG. 1A illustrates an exemplary embodiment of a remote viewing device;

FIG. 1B illustrates an exemplary viewing head assembly for the remote viewing device of FIG. 1;

FIG. 1C illustrates a cross-sectional view of the exemplary viewing head assembly of FIG. 1B;

FIG. 2A illustrates an exemplary embodiment of an optical image processing system for use with the remote viewing device of FIG. 1;

FIG. 2B illustrates other aspects of the exemplary optical image processing system of FIG. 2A.

FIG. 3 illustrates a pixel matrix that includes an active display area;

FIG. 4 illustrates the pixel matrix of FIG. 3 additionally including a grid image that is aligned with the mechanical axis of the viewing head assembly of the remote viewing device of FIG. 1;

FIG. 5 illustrates the pixel matrix of FIG. 4 that includes an alternative, relocated active display area;

FIG. 6 illustrates another pixel matrix that includes an active display area and an alternative, relocated active display area;

FIG. 7A illustrates a pixel matrix for a remote viewing device that includes a stereoscopic optical tip; and

FIG. 7B illustrates a pixel matrix for a remote viewing device that includes a stereoscopic optical tip with a roof prism.

### DETAILED DESCRIPTION OF THE INVENTION

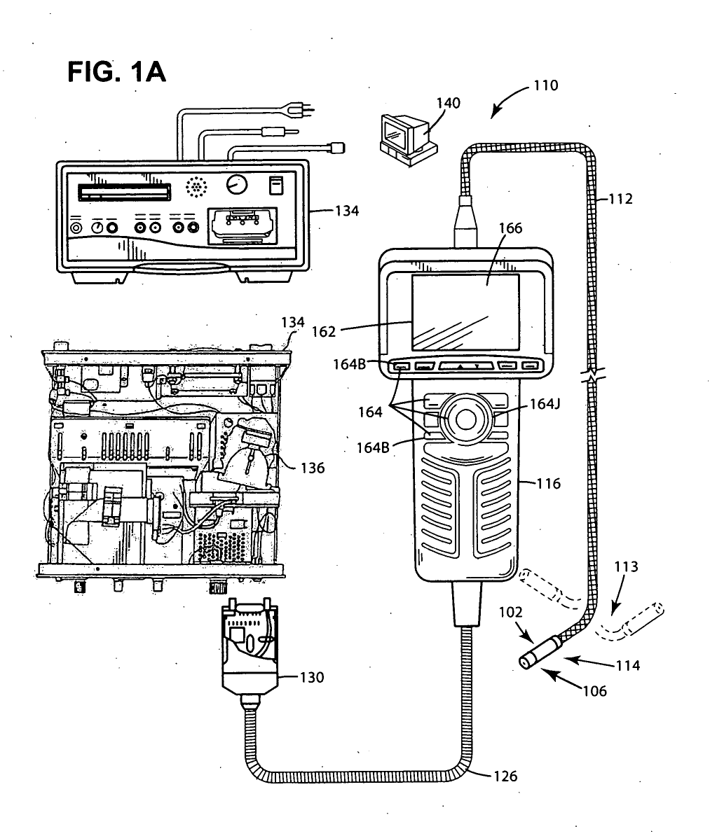

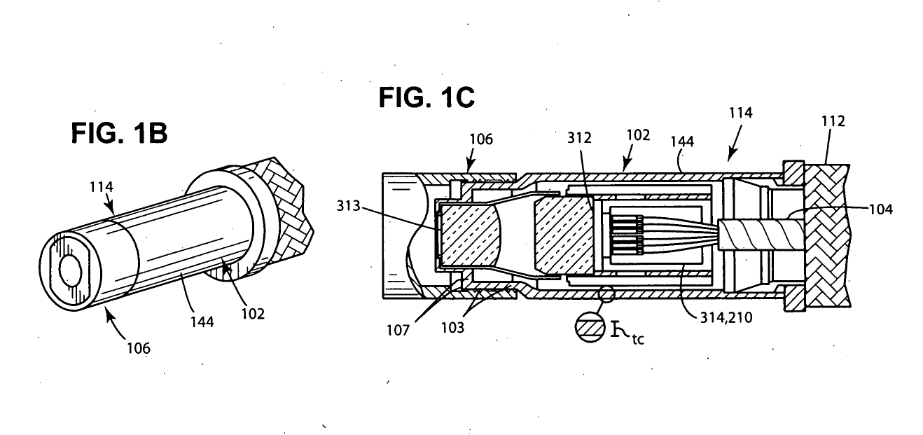

FIG. 1A illustrates an exemplary embodiment of a remote viewing device 110. The depicted remote viewing device 110 includes a detachable optical tip 106 and a viewing head 102, each of which comprises a portion of a viewing head assembly 114. As best shown in FIGS. 1B and 1C, the viewing head assembly 114 also includes a metal canister (can) 144 that surrounds an imager (also interchangeably referred to herein as an image sensor) 312 and associated lenses 313, 315 that direct and focus incoming light towards the imager.

The remote viewing device 110 also includes various additional components, such as a light box 134, a power plug 130, an umbilical cord 126, a hand piece 116, and an insertion tube 112, each generally arranged as shown in FIG. 1A. The light box 134 includes a light source 136 (e.g., a 50-Watt metal halide arc lamp) that directs light through the umbilical cord 126, the hand piece 116, the insertion tube 112, and then outwardly through the viewing head assembly 114 into the surrounding environment in which the remote viewing device 110 has been placed.

The umbilical cord 126 and the insertion tube 112 enclose fiber optic illumination bundles (not shown) through which light travels. The insertion tube 112 also carries at least one articulation cable that enables an end user of the remote viewing device 110 to control movement (e.g., bending) of the insertion tube 112 at its distal end 113.

The detachable optical tip 106 of the remote viewing device 110 passes (e.g., via a glass piece, prism or formed fiber bundle) outgoing light from the fiber optic illumination bundles towards the surrounding environment in which the remote viewing device has been placed. The tip 106 also includes at least one lens 315 to receive incoming light from the surrounding environment. If desired, the detachable optical tip 106 can include one or more light emitting diodes (LEDs) or other like equipment to project light to the surrounding environment.

It is understood that the detachable optical tip 106 can be replaced by one or more other detachable optical tips with differing operational characteristics, such as one or more of differing illumination, light re-direction, light focusing, and field/depth of view characteristics. Alternatively, different light focusing and/or field or depth of view characteristics can be implemented by attaching different lenses to different optical tips 106.

In accordance with an exemplary embodiment, an image processing circuit (not shown) can reside within the light box 134 to process image information received by and communicated from the viewing head 102. When present, the image processing circuit can process a frame of image data captured from at least one field of light passing through the at least one lens 315 of the optical tip 106. The image processing circuit also can perform image and/or video storage, measurement determination, object recognition, overlaying of menu interface selection screens on displayed images, and/or transmitting of output video signals to various components of the remote viewing device 110, such as the hand piece display 162 and/or the visual display monitor 140.

A continuous video image is displayed via the display 162 of the hand piece 116 and/or via the visual display monitor 140. The hand piece 116 also receives command inputs from a user of the remote viewing device 110 (e.g., via hand piece controls 164) in order to cause the remote viewing device to perform various operations.

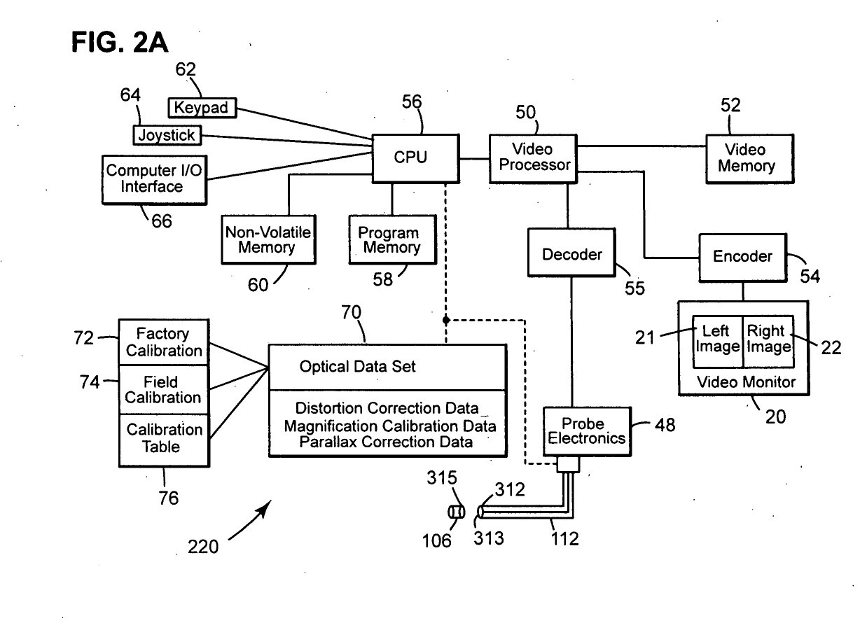

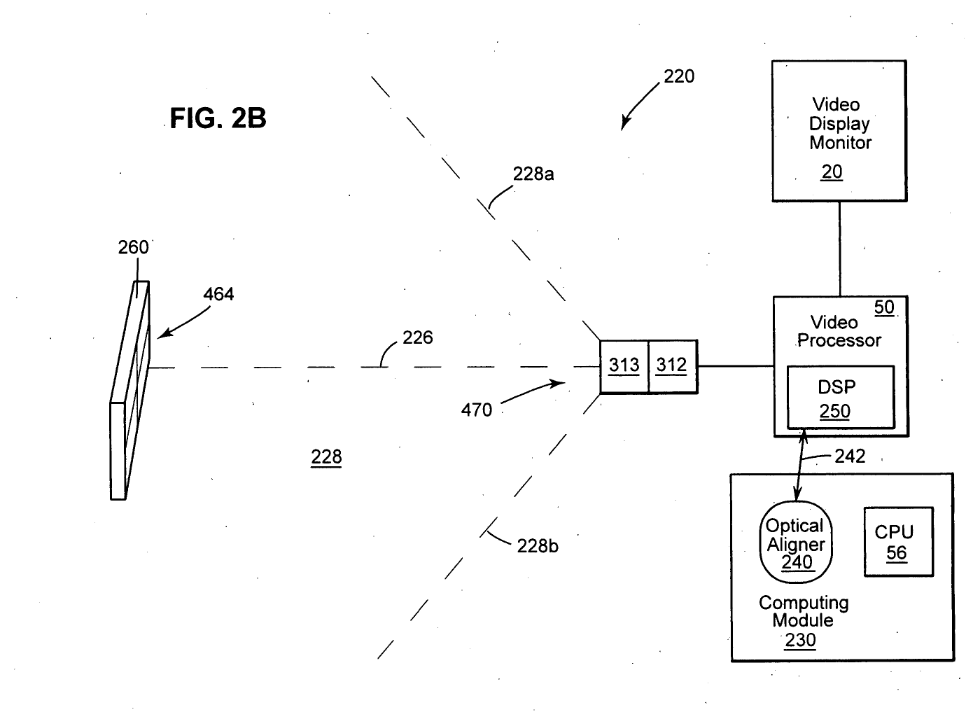

In an exemplary embodiment, and as illustrated in FIG. 2A, a pixel matrix 54 or other encoder can be shunted directly to a display, such as the hand piece display 162 and/or the visual display monitor 140, without being stored into video memory. Alternatively, the pixel matrix 54 can be stored into video memory 52 and displayed on the hand piece display 162 and/or on the visual display monitor 140.

The hand piece 116 includes a hand piece control circuit (not shown), which interprets commands entered (e.g., through use of hand piece controls 164) by an end user of the remote viewing device 110. By way of non-limiting example, some of such entered commands can control the distal end 113 of insertion tube 112, such as to move it into a desired orientation. The hand piece controls 164 can include various actuatable controls, such as one or more buttons 164B and/or a joystick 164J. If desired, the hand piece controls 164 also can include, in addition to or in lieu of some or all of the actuatable controls, a means to enter graphical user interface (GUI) commands.

In an exemplary embodiment, the image processing circuit and hand piece processing circuit are microprocessor-based and utilize one or a plurality of readily available, programmable, off-the-shelf microprocessor integrated circuit (IC) chips having on-board volatile program memory 58 (see FIG. 2A) and non-volatile memory 60 (see FIG. 2A) that store and that execute programming logic and are optionally in communication with external volatile and nonvolatile memory devices.

FIG. 1B illustrates an exemplary embodiment of a viewing head assembly 114 that includes a viewing head 102 and a detachable optical tip 106, such as those depicted in FIG. 1A. The viewing head 102 includes a metal canister 144, which encapsulates a lens 313 and an image sensor 312 (both shown in FIG. 1C), as well as elements of an image signal conditioning circuit 210. If desired, and as illustrated in FIG. IC, the viewing head 102 and the detachable optical tip 106 can include, respectively, threads 103, 107, which enable the optical tip 106 to be threadedly attached and detached to the viewing head 102 as desired. It is understood, however, that other conventional fasteners can be substituted for the illustrated threads 103, 107 so as to provide for attachment and detachment of the optical tip 106 to and from the viewing head 114.

As noted above, the viewing head 102 depicted in FIG. 1C includes a viewing head assembly 114, an imager 312, an associated lens 313, and a threaded area 107. Although not shown, it is understood that there can be more than one lens 313 associated with the imager 312, wherein the term “associated” refers to the lens(es) being attached to and/or positioned relative to (e.g., axially aligned with) the imager. The viewing head assembly 114 includes an optical tip 106 with an associated lens 315 and threads 103 along an inner surface. As shown, and in accordance with an exemplary embodiment, the threads 103 of the tip 106 are threadedly engaged with the threads 107 of the viewing head 102 to attach the tip 106 to the viewing head 102. When the tip 106 is attached to the viewing head 102 as such, the lens 315 associated with the tip 106 is disposed and aligned in series with the lens 313 associated with the imager 312 of the viewing head 102.

Also as depicted in FIG. IC, a metal canister (can) 144 encapsulates the imager (image sensor) 312, the lens 313 associated with the imager, and an imager component circuit 314. The imager component circuit 314 includes an image signal conditioning circuit 210, and is attached to a wiring cable bundle 104 that extends through the insertion tube 112 to connect the viewing head 102 to the hand piece 116. By way of non-limiting example, the wiring cable bundle 104 passes through the hand piece 116 and the umbilical cord 126 to the power plug 130 of the remote viewing device 110.

FIG. 2A illustrates an exemplary embodiment of an optical image processing system of a remote viewing device 110. In accordance with this exemplary embodiment, the remote viewing device 110 includes a detachable stereo optical tip 106, which itself houses an optical lens system 315 that is adapted to split images. The splitting of images can occur by the optical system including left and rights lenses, or, alternatively, through use of a roof prism device, such as is described in U.S. patent application Ser. No. 10/056,868, the entirety of which is incorporated by reference herein. Also in this exemplary embodiment, and as further shown in FIG. 2A, an imager 312 and an associated lens 313 are included at the distal end 113 of the insertion tube 112 of the remote viewing device 110.

Referring further to the components of the exemplary optical image processing system of FIG. 2A, an optical data set 70 is provided, and, as is currently preferred, is stored in non-volatile memory 60 within the probe electronics 48, thus rendering it accessible to a central processing unit (CPU) 56. The probe electronics 48 also serve to convert signals from the imager 312 into a format that is accepted by a video decoder 55. In turn, the video decoder 55 produces a digitized version of the image produced by probe electronics 48. A video processor 50 stores this digitized image in a video memory 52, which is accessible by the CPU 56 in order to access the digitized image.

The CPU 56, which, as is currently preferred, accesses both a non-volatile memory 60 and a program memory 58, operates upon the digitized stereo or non-stereo image residing within video memory 52. A keypad 62, a joystick 64, and a computer I/O interface 66 convey user input (e.g., via cursor movement) to the CPU 56. The video processor 50 can superimpose graphics (e.g., cursors) on the digitized image as instructed by the CPU 56. An encoder 54 converts the digitized image and superimposed graphics, if any, into a video format that is compatible with a viewing monitor 20. The monitor 20 is shown in FIG. 2A as displaying a left portion 21 and a right portion 22 of a stereo image; however, it is understood that the viewing monitor 20 can display non-stereo images, if instead desired.

In an exemplary embodiment, a quality assurance (QA) operator is trained to view a digitized image displayed on the monitor 20 to identify one or more locations of interest within the digitized image. By way of non-limiting example, the QA operator can identify the location(s) of interest by locating a cursor that is displayed via the monitor 20 and then pressing one or more buttons of a pointer location device (e.g., a mouse) associated with the cursor. In one exemplary mode of operation, the location(s) of interest can be selected from a digitized image that encompasses an entire image that is sensed by the imager 312. The location(s) of interest can define a center location and the boundaries of an active display area, wherein the location of the active display area can be modified by the QA operator to adapt the operation of the remote viewing device to at least one misaligned lens 313, 315.

FIG. 2B illustrates a top perspective view of other aspects of an exemplary optical image processing system 220 of the remote viewing device 110. As shown, an imager 312 is physically aligned along an optical axis 226 in a direction substantially towards a target 260 that has a known relationship with respect to (e.g., substantially aligned with) the optical axis. In the illustrated FIG. 2B embodiment, and by way of non-limiting example, this target 260 can be a grid. It is also understood, however, that one or more other devices can be used in lieu of and/or in addition to a grid, wherein such other device(s) can include, for example, a laser, a light emitting diode (LED) and/or any visible pattern (e.g., a dot or a backlit pattern). The lens 313 associated with the imager 312 should be aligned along this optical axis 226 as well, or, because of a manufacturing error, it and/or the imager may be misaligned (i.e., not aligned along the optical axis 226).

During image processing, a field of light 228 having approximate boundaries 228a, 228b enters the lens 313 and is inputted to the imager 312. The field of light 228 entering the imager 312 communicates an image 470 to the imager 312 that includes at least a portion of a grid image 464. The communicated image 470 is electronically represented by a pixel matrix 54 residing within a video processor 50.

An optical aligner module 240 is configured to communicate with, and to control the operation of, a digital signal processor (DSP) 250 via a communications interface 242. In one exemplary embodiment, the DSP 250 is a CXD3150R digital signal processor, as is currently manufactured by Sony. It should be noted that the DSP 250, as shown schematically in FIG. 2B, can represent one or more integrated circuits (ICs) in addition to a digital signal processor, such additional IC(s) including, but not necessarily limited to, an analog front end IC and/or a timing generator IC. When included, the analog front end IC can be, e.g., a CXD3301R model and the timing generator IC can be, e.g., a CXD2494R model, both also as presently manufactured by Sony.

The optical aligner module 240 is a software module that resides within a computing module 230 of the remote viewing device 110. The computing module 230 also includes a central processing unit (CPU). The digital signal processor (DSP) 250 is configured to process the communicated image 470 as it is represented by the pixel matrix 54. The DSP 250 relays a portion of the image 470, defined by an active display area, to a video display monitor 20. The optical aligner 240 directs the operation of the DSP 250 in order to define a portion of the image 470 that constitutes the active display area and to adapt the optical system 220 to at least one potentially misaligned lens 313, 315.

The CXD3150R model DSP is designed to cut out a display window (i.e., an active display area) having a horizontal dimension of 720 pixels from a sensed image (i.e., a pixel matrix 54) having a horizontal dimension of 960 pixels. The sensed image is communicated by the imager 312 to the DSP 250. Additionally, the DSP 250 (e.g., the CXD3150R) is configured to provide a plurality of registers, which can include, by way of non-limiting example, registers to control the positioning of the active display area within the pixel matrix 54.

It is currently preferred for the various registers of the DSP 250 to be configured so as to be addressable from a CPU 56 via a bus (not shown) that is located with the computing module 230. The optical aligner 240 (which, as is currently preferred, is implemented as software that executes via the CPU 56) directs the operation of the DSP 250 by reading and storing values within the various registers of the DSP. Other exemplary embodiments can include, but are not limited to, a microprocessor or a DSP (other than a Sony CXD3150R model) and associated IC(s) that is/are configured to define and process (i.e., cutout) a subset of an image as an active display area, such as in manner similar to the horizontal and/or vertical cutout feature of a Sony CXD3150R model.

The CXD3150R model DSP 250 has various modes of operation regarding the active window that can be cut out from the sensed image. In one exemplary mode of operation, an NTSC (720×480 pixel area) active display area is cut out and displayed via the monitor 20. In another mode of operation, a PAL (720×576 pixel area) active display area is cut out and displayed via the monitor 20. In an REC656 mode of operation, a NTSC or PAL sized pixel area of the sensed image is cut out and not immediately (i.e., not directly) displayed on the monitor 20. Instead, the pixel area is represented by a digital signal that may be received and processed by other components. To that end, and by way of non-limiting example, a digital signal can be input into a scaling component, such as a scaler chip or a graphics engine of a personal computer. In this REC656 mode of operation, the pixel area (i.e., active display area) is cut out from the sensed image and scaled before being displayed on the viewing monitor 20.

This REC656 mode of operation is currently preferred because it can be used to provide comparatively more control of the active display area and to adapt to different display resolution requirements across personal computers. Personal computer displays generally input a progressive scan signal and hardware, such as an SII 504 de-interlacer chip, and can be used to de-interlace the digital signal (i.e., to convert it to a progressive scan signal) if the imager 312 outputs an interlaced signal. A Texas Instruments TMS320DM642 digital signal processor, as one example, can perform actual scaling of a progressive scan signal before it is displayed via the viewing monitor 20.

As noted above, a QA operator can be trained to view a digitized image via the monitor 20 and to identify one or more locations of interest within the digitized image. In a first exemplary mode of operation, a first digitized image encompasses an entire image sensed by an imager 312. In a second mode of operation, a second digitized image encompasses an active display area, which is a subset of the entire image sensed by an imager 312. The QA operator can identify patterns of illumination in combination with at least a portion of a grid image 464 in order to relocate the active display area within the entire image. The QA operator can identify one or more locations of interest by, for example, locating a cursor and pressing one or more buttons of a pointer location device (e.g., a mouse) associated with the cursor that is also displayed on the viewing monitor 20 within the first digitized image. The location(s) of interest can define the center location and/or the boundaries of the active display area at a new (i.e., relocated), alternative location.

The optical aligner 240 of the optical image processing system 220 inputs the location(s) of interest and directs the DSP 250 to alter the location of (i.e., to relocate) the active display area within the entire image in order to respond to the QA operator. The QA operator can view the second digitized image to visually locate a newly defined, alternative active display area. As is currently preferred, the location of the active display area is altered by the operation of the DSP 250 in response to the location(s) of interest that is/are input by the operator via an interactive user interface. In accordance with an exemplary embodiment, the QA operator's interaction with the optical aligner 240 is iterative in order to verify that there is sufficient alignment of the grid image 464 to allow for adaptation of the remote viewing device 110 to at least one misaligned lens.

Relocation of the active display area can occur in various ways. By way of non-limiting example, the active display area can be relocated while an optical tip 106 including a lens 315 is attached to the remote viewing device 110. Alternatively, the active display area can be relocated while an optical tip 106 is detached from the remote viewing device 110.

In accordance with an exemplary embodiment, the QA operator, or an automated quality assurance method, takes steps in order to ensure that the grid 260 is properly positioned whereby the imager 312 is physically aligned along the optical axis 226 that is directed towards the grid. Ideally, the optical axis 226 intersects the grid 260 at a center location of the grid 260. Proper positioning of the grid 260 is useful because a mispositioned grid in combination with at least one misaligned lens 313, 315 may cause a grid image 464 that is associated with the grid to appear aligned when viewed from the viewing monitor 20, 140. For example, the grid 260 may be positioned 15 degrees away from the optical axis 226 such that a similar degree of misalignment of the lens 313 and/or the lens 315 can cause the grid image 464 associated with the grid 260 to appear aligned when viewed by the operator from the monitor 20, despite that not being the case.

Certain manufacturing requirements presently specify that the grid 260 must be positioned within 1 degree or within 2 degrees of the optical axis 226. In such instances, the QA operator, or an automated quality assurance method, can verify the alignment of the grid image 464 while verifying proper alignment of the grid 260 relative to the optical axis 226 of the imager 312.

Unlike the techniques described in the '977 patent, the above-described exemplary embodiments do not rely upon altering relative timing between one or more synchronization signals and an image signal. As such, these exemplary embodiments allow for altering a position of a displayed image (i.e., an active display area) to more than 30% of either dimension of an entire image that is sensed by an imager 312. Accordingly, such exemplary embodiments provide substantially more flexibility for defining the size and location of the displayed image relative to the sensed image, and in terms of a relatively wide range of coordinates. Further, a misaligned lens may require more flexibility for defining the size and location of the displayed image relative to the sensed image than can be provided by a technique such as that which is described in the '977 patent.

Various imagers 312 can be employed in combination with various DSPs or microprocessors in furtherance of the exemplary embodiments described herein. In one exemplary embodiment, the imager 312 is an ICX280HK NTSC image sensor 312 or an ICX281AKA PAL image sensor 312, both as currently manufactured by Sony. These particular imagers 312 are configured as a charge-coupled device (CCD) image sensors that are suitable for the NTSC and PAL standards of color video cameras, and they support 33% panning and/or tilting. Moreover, such imagers 312 can be embedded into a color CCD microcamera of a remote viewing device 110, such as a CCD microcamera that is commercially available from 3D Plus Inc. of McKinney, Tex.

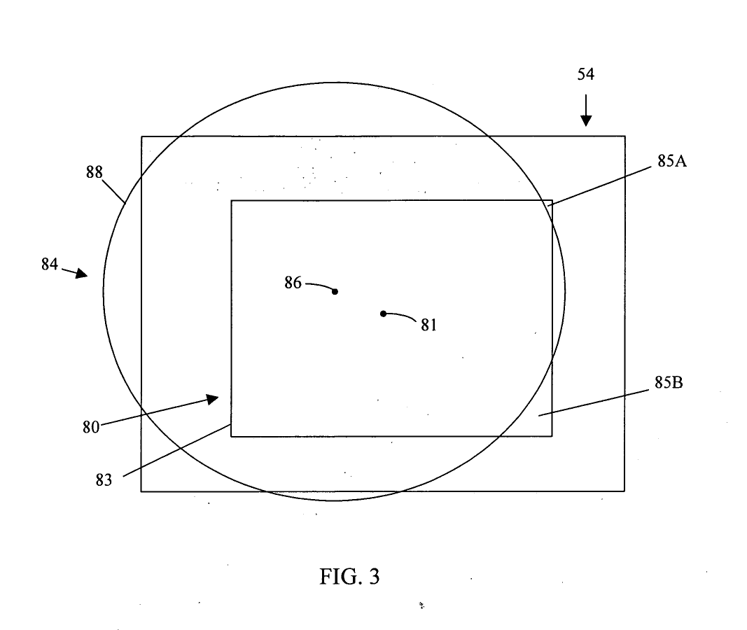

FIG. 3 illustrates a pixel matrix 54, also referred to as a pixel array, which is an arrangement of a plurality of pixels that reside within the imager 312. The pixel matrix 54 is used to capture at least one field of light passing through the lens(es) 313 associated with the imager 312. Only an illumination area 84, which illuminates a subset of the pixels within the pixel matrix 54, captures any significant amount of light passing through the lens 313 of the imager 312. The illumination area 84 has a perimeter 88 and typically illuminates a contiguous area of pixels that are located within the pixel matrix 54. Other pixels within the pixel matrix 54, namely those residing outside the illumination area 84, remain relatively dark and capture significantly less, if any amount of light that passes through the lens(es) 313. The imager (image sensor) 312 can be a charged coupled device (CCD) or CMOS imager, can be color or monochrome, and can be configured to output either a progressive or interlaced image.

A second subset of the pixels within the pixel matrix 54, namely the active display area 80, includes pixels whose locations are independent of those pixels residing within the illumination area 84. The active display area 80 typically forms a contiguous rectangular area of pixels having a perimeter 83. As shown in FIG. 3, the default, initial location of the active display area 80 generally is vertically and horizontally centered with regard to the pixel matrix 54 such that the center location 81 of the active display area also corresponds to the center location of the pixel matrix.

Depending upon the relative alignment of the lens 313 with respect to the imager 312, there may or may not be a significant number of pixels residing within both the illumination area 84 and the active display area 80. If the lens 313 is optimally aligned with the imager 312, then the entire or substantially the entire perimeter 83 of the active display area 80 will be located within the perimeter 88 of the illumination area 84. This is not the case in FIG. 3, which illustrates that two portions 85A, 85B of the active display area 80 are located outside of the perimeter 88 of the illumination area 84. This existence of one or more of such portions 85 is indicative of one or more misaligned lens(es) 313, 315 and would disadvantageously cause an image viewed on a viewing monitor 20 to have one or more optical defects, such as one or more dark, blurred and/or glared areas.

In accordance with an exemplary embodiment, this misalignment lens(es) 313, 315 problem can be corrected by shifting the location of (i.e., by repositioning or relocating) the active display area 80 within the pixel matrix 54, such as via the probe electronics 48. By way of non-limiting example, software residing within the remote viewing device 110 can interface with the imager 312 and can direct the imager to reposition (i.e., to relocate) the active display area 80 to mitigate and/or compensate for a misaligned lens 313, 315. Alternatively, the imager 312 can be a passive device, in which case the DSP 250 can be directed to reposition the active display area 80. Either way, the presence of one or more optical defects caused by at least one misaligned lens 313, 315 can be corrected by adjusting the location of (i.e., by repositioning) the active display area 80 within the pixel matrix 54.

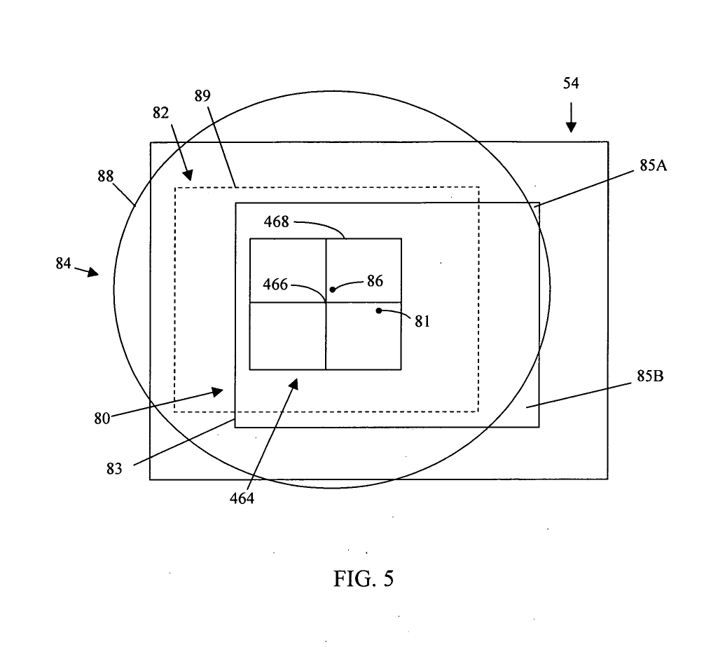

This repositioning of the active display area 80 can occur though use of charge-coupled device (CCD) and CMOS imager chips, such as through use of an electronic imager stabilization function. By way of non-limiting example, a SONY ICX280HK imager chip can be controlled in a way to electronically select the location of the active display area 80 of the imager such that only pixels within the active display area are provided as video output from the remote viewing device 110. Thus, the remote viewing device 110 can use this type of imager chip to automatically set and reposition the location of the active display area 80, wherein the location of the active display area within the pixel matrix 54 is stored in software accessible memory. Such repositioning/relocation is shown in FIG. 5 and is discussed below.

In an alternate embodiment, the DSP 250 can selectively receive a subset of the pixel matrix 54 from the imager 312, wherein the subset includes the active display area 80. In an additional alternate embodiment, the DSP 250 can read and process pixels within the active display area 80 from a frame buffer in a memory (not shown).

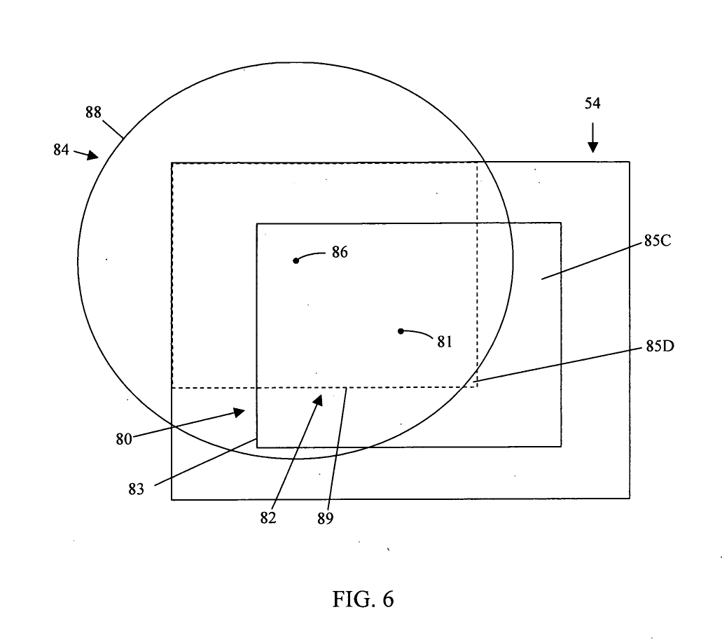

In some circumstances (see, e.g., FIG. 6, as discussed below), it may not be possible to reposition the active display area 80 to lie entirely within the illumination area 84. If so, a QA operator can assess whether the remote viewing device 110 still can function satisfactorily (e.g., if the active display area 80 lies substantially entirely within the perimeter 88 of the illumination area 84), or if, instead, the size and/or amount of areas 85 of the active display area 80 that lie outside of the perimeter of the illumination area 84 require the imager 312 and/or the lens 313 to be scrapped or repaired.

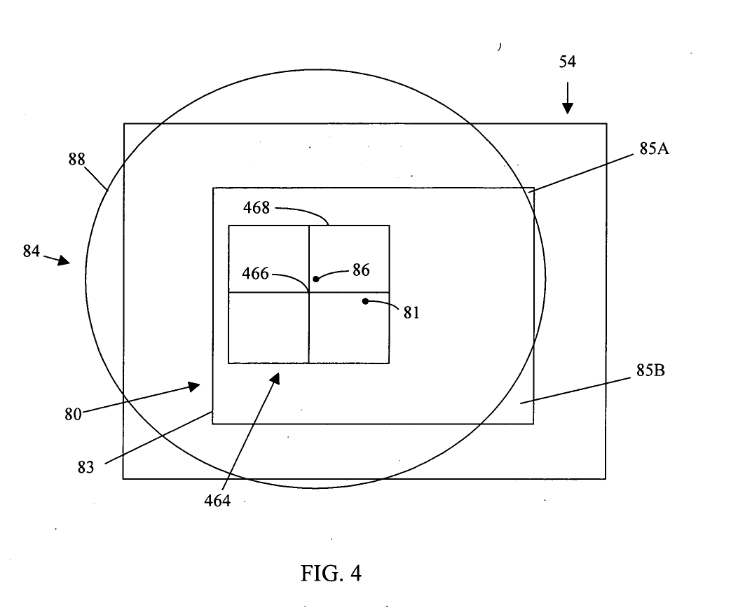

FIG. 4 illustrates the pixel matrix 54 of FIG. 3 further including a grid image 464, which is formed by light reflecting from a grid 260 that is partially located within the field of view of the lens 313 of the imager 312. The grid image 464 has a center location 466 and a perimeter 468, and is axially aligned with the optical axis 226 of the imager 312. In an exemplary embodiment, identifying and communicating the center location 466 of the grid image 464 is performed by pattern recognition software, which identifies and communicates a location within the pixel matrix 54 that is most proximate to the center location 466 of the grid image 464. Additional software is then used to map the center location 81 of the active display area 80 to the center location 466 of the grid image 464.

Placement of the grid image 464 relative to active display area 80 can provide a further indication (in addition to the size and/or amount of areas 85 of the active display area 80 lying outside of the illumination area 84) as to whether and to what extent lens(es) 313, 315 are aligned or misaligned with respect to the imager 312. If lens(es) 313, 315 are properly aligned, then the center location 466 of the grid image 464 will be at or substantially proximate the center location 81 of the active display area 80. Here, however, the center locations 81, 466 are offset from one another, thus further confirming misalignment of one or more of the lens(es) 313, 315 with respect to the imager 312. Generally, the larger the offset distance between the respective center locations 81, 466, the more misaligned the lens(es) 313, 315 is/are with respect to the imager 312.

FIG. 5 illustrates the pixel matrix 54 of FIG. 4 with the addition of an alternative active display area 82 having a perimeter 89. The alternative active display area 82 represents the relocation of the active display area 80 of FIGS. 3 and 4 to a new position within the pixel matrix 54. The alternative active display area 82 is not centered within the pixel matrix 54, but its perimeter 89 is entirely included within the perimeter 88 of the illumination area 84. Additionally, the center location of the alternative active display area 82 coincides with the center location 466 of the grid image 464.

Thus, when the active display area 80 is repositioned to form the alternative active display area 82 in FIG. 5, the resulting image that is viewed on the viewing monitor 20 would be beneficially comparable to that which would be viewed if the misaligned lens(es) 313, 315 had been aligned with the imager 312 as manufactured. This is because relocating the active display area 80 to the alternative active display area 82 essentially aligns the as-manufactured axial position of the lens(es) 313, 315 to the axial position of the associated imager 312 whereby the entire field of light passing through the lens(es) now resides within the alternative active display area 82. Thus, the viewed image on the monitor 20 would be free of optical defects such as one or more dark, blurry and/or glared areas, as would be present due to the misalignment condition shown in FIGS. 3 and 4.

It should be noted that it may be impossible to reposition the active display area 80 to form an alternative active display area 82 in a manner that causes both (a) the center location of the alternative active display area to coincide with or to be located substantially proximate the center location 466 of the grid image 464, and (b) the perimeter 89 of the active display to lie entirely or substantially entirely within the perimeter 88 of the illumination area 84. In such instances, it is currently more preferred for the center locations 81, 466 to be somewhat offset if that also means the entire or substantially the entire perimeter 89 of the alternative active display area 82 would lie within the perimeter 88 of the illumination area 84, since the resulting image viewed on the monitor 20 generally would include comparatively fewer and/or smaller optical defects than if, instead, the center locations 81, 466 were not offset but less than substantially the entire perimeter 89 of the alternative active display area 82 was outside of the perimeter 88 of the illumination area 84. In other words, if forced to choose between offset center locations 81, 466 versus a non-nominal portion of the perimeter 89 of the alternative active display area 82 lying outside of the illumination area 84, the former is currently favored over the latter.

FIG. 6 illustrates a pixel matrix 54 that includes a centered active display area 80 wherein a large portion 85C of the active display area disadvantageously lies outside of the illumination area 84. As noted above, this is indicative of optical misalignment. To attempt to correct this problem, the active display area 80 has been repositioned as shown in order to form an alternative active display area 82, which is shown in phantom and which has a perimeter 89. However, because the alternative active display area 82 still must be entirely contained within the pixel matrix 54, it is also disadvantageously impossible, in this instance, for the entire perimeter 89 of the alternative active display area 82 to be located within the perimeter 88 of the illumination area 84.

The FIG. 6 location of the alternative active display area 82 represents the best possible location of the alternative active display area 82 under the circumstances, wherein only a small portion 85D—but a portion nonetheless—of the alternative active display area 82 is located outside of the illumination area 84. In instances such as this wherein it is impossible to position the alternative active display area 82 such that it is located entirely within the perimeter 88 of the illumination area 84, it is currently preferred to do what is shown in FIG. 6, namely to position the alternative active display area 82 as ideally as possible (i.e., such that its perimeter 89 is substantially entirely within the perimeter 88 of the illumination area 84) in hopes of correcting the misalignment problem to an extent wherein the optical misalignment has been corrected such that the image produced on the monitor 20 would contain optical defects that are few enough in number and/or small enough in size so as to allow for satisfactory operation of the remote viewing device 110. Here, because there is only a single small portion 85D of the alternative active display area 82 that is located outside of the illumination area 84 in FIG. 6, it is likely that the remote viewing device 110 can be operated satisfactorily such that the image produced on the viewing monitor 20 will be substantially, although perhaps not entirely, free of optical defects (e.g., one or more of blurring, dark spots and/or glare). If, instead, the optimal positioning of the alternative display area 82 still results in portion(s) 85 located outside of the perimeter 88 of the illumination area 84 that are too many in number and/or too large in size, then the remote viewing device 110 would not be capable of producing a suitable viewing image that is substantially free of optical defects. In turn, one or more portions (e.g., the optical tip 106, one or more of lenses 313, 315, the imager) of the remote viewing device 110 would need to be repaired or scrapped.

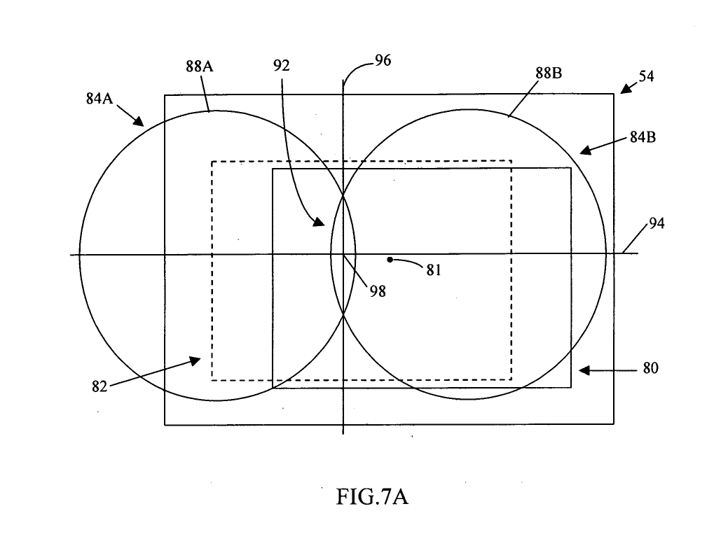

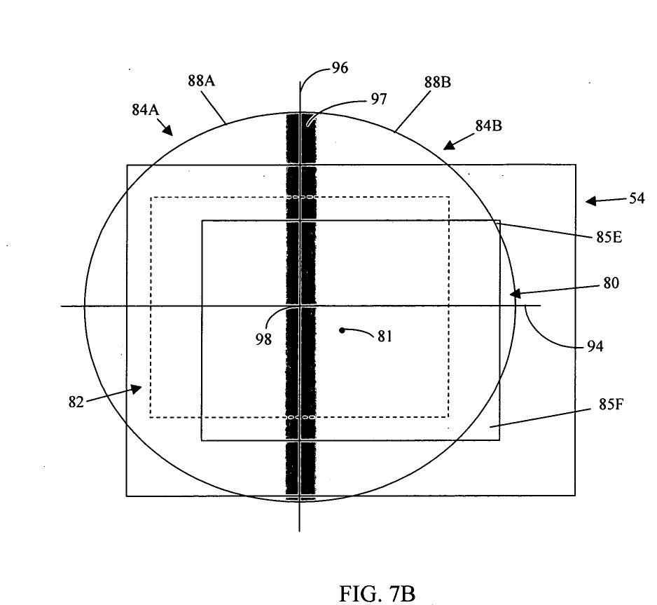

Referring now to FIG. 7A, it depicts a pixel matrix 54 for an exemplary stereoscopic application of a remote viewing device 110. Here, the pixel matrix 54 at least partially contains two illumination areas 84A, 84B, each of which has a respective perimeter 88A, 88B. The illumination areas 84A, 84B overlap at an overlap region 92, wherein a horizontal line 94 and a vertical line 96 intersect at a location 98 of the overlap region. The intersection location can be, but is not required to be, located at the center of the overlap region 92. The pixel matrix 54 also includes an active display area 80 that is centered with respect to the pixel matrix and that includes a center location 81.

If the lens(es) 313, 315 associated with the imager 312 was/were properly aligned, then the center location 81 of the active display area 80 would be located at or substantially proximate to the intersection location 98 within the overlap region 92 of the illumination areas 84A, 84B. As shown in FIG. 7A, however, this is not the case. Instead, the center location 81 of the active display area 80 is non-nominally horizontally offset with respect to the intersection location 98. Thus, on at least this basis, it is reasonable to conclude that one or more of the lens(es) 313, 315 associated with the imager 312 are misaligned. The misalignment problem can be sought to be corrected via one or the exemplary techniques discussed above, such as by relocating the active display area 80 to form an alternative active display area 82, as shown in phantom in FIG. 7A. In this instance, the misalignment problem has been corrected because the center location of the alternative active display area 82 is located at or substantially proximate to the intersection location 98 of the overlap region 92 of the illumination areas 84A, 84B.

The exemplary embodiment of FIG. 7B depicts a similar optical misalignment problem and solution as were illustrated in FIG. 7A. However, in the FIG. 7B exemplary embodiment, the tip 106 of the remote viewing device 110 is a stereo tip that includes a roof prism, such as is described in U.S. patent application Ser. No. 10/056,868, the entirety of which is incorporated by reference herein.

The usage of a roof prism in the FIG. 7B exemplary embodiment creates a visually apparent blurring band 97, which is induced by the optical characteristics of the apex of the roof prism. As shown, the blurring band 97 occurs at the division between the two stereo image illumination areas 84A, 84B, wherein the horizontal center of this division is located at vertical line 96. In the FIG. 7B exemplary embodiment, optical misalignment is suggested by the fact that the vertical line 96 does not coincide with the center location 81 of the active display area 80, and because there are two regions 85E, 85F of the active display area that lie outside the perimeter 88B of the illumination area 84B. Optical misalignment in this instance, as with the others previously described, would cause the occurrence of one or more other visually apparent optical defects, such as blurring (i.e., in addition to the blurring band 97), and/or one or more of glare or dark regions.

As with the FIG. 7A embodiment, however, the apparent misalignment problem shown in FIG. 7B can be corrected via one or the exemplary techniques discussed above, such as by relocating the active display area 80 to form an alternative active display area 82, as shown in phantom. And as with the FIG. 7A exemplary embodiment, the optical misalignment problem of FIG. 7B has been corrected because the center location of the alternative active display area 82 is located at or substantially proximate the intersection location 98 between the vertical line 96 and the horizontal line 94, which is located substantially proximate the vertical center of the illumination areas 84A, 84B.

Although not shown, the illuminations areas 84A, 84B of FIG. 7A or 7B can be non-overlapping. In such instances, and by way of non-limiting example, one can determine whether there lens misalignment by inserting a vertical line 96 between the non-overlapping illumination areas 84A, 84B and then inserting a horizontal line 94 such that the point at which the lines 94, 96 intersect is defined as an intersection location 98. If the center location 81 of the active display area 80 is offset from the center intersection location 98 then there is likely optical misalignment. If that is the case, then the active display area 80 can be repositioned/relocated such that an alternate active display area 82 is created which has a center location that is located at or substantially proximate to the intersection location 98, thus correcting the optical misalignment.

Although also not shown in above-described embodiments, it is noted that illumination area pixel identification software can identify pixels residing within the one or more illumination area 84 by measuring the illumination value of each pixel residing within the pixel matrix 54. Pixels having an illumination value below a predetermined illumination threshold value are classified as residing outside of the illumination area(s) 84, whereas pixels having an illumination value at or above the predetermined illumination threshold value are classified as residing inside the illumination area(s) 84. Contiguously located pixels, classified as residing inside the illumination area(s) 84, are consolidated into the same illumination area(s) 84. In some circumstances, such as when using a stereo optical tip (see exemplary FIGS. 7A and 7B), the pixel identification software may consolidate pixels that form multiple illumination areas 84A, 84B within the pixel matrix 54.

Illumination, as referred to herein, is a measure of brightness as seen through the human eye. In one exemplary grayscale embodiment, illumination is represented by an 8 bit (1 byte) data value encoding decimal values 0 through 255. Typically, a data value equal to 0 represents black and a data value equal to 255 represents white. Shades of gray are represented by values 1 through 254. The aforementioned exemplary embodiments can apply to any representation of an image for which illumination can be quantified directly or indirectly via a translation to another representation. By way of non-limiting example, and with respect to embodiments that process a color image, the color space models that directly quantify the illumination component of image pixels, including but not limited to those referred to as the YUV, YCbCr, YPbPR, YCC and YIQ color space models, can be used to directly quantify the illumination (Y) component of each (color) pixel of an image as a pre-requisite to measuring the illumination of pixels within the pixel matrix 54.

Also, color space models that do not directly quantify the illumination of image pixels, including but not limited to those referred to as the red-green-blue (RGB), red-green-blue-alpha (RGBA), hue-saturation-(intensity) value (HSV), hue-lightness-saturation (HLS) and the cyan-magenta-yellow-black (CMYB) color space models, can be used to indirectly quantify (determine) the illumination component of each (color) pixel. For these types of embodiments, a color space model that does not directly quantify the illumination component of image pixels, such as the RGB color space model for example, can be translated into a color space model, such as the YCbCr color space model for example, that directly quantifies the illumination component for each pixel of the pixel matrix 54. This type of translation can be performed as a pre-requisite to performing illumination area pixel identification. Alternatively, color components themselves (e.g., green in RGB color space) that have a relationship to illumination intensity could be used directly. It is also understood that light having a predetermined wavelength could be used to produce the illumination area(s) 84, and color components responsive to the predetermined wavelength could be directly analyzed.

When illumination area 84 pixels are identified, illumination pattern analysis software can be further employed to determine a center location of the identified illumination area(s) 84. In an exemplary embodiment, the center location of the illumination area is equal to the geometric center of the illumination area 84 as determined by the illumination pattern analysis software. The illumination pattern analysis software is a type of specialized image processing software that identifies and characterizes one or more contiguous groupings of illumination pixels.

The illumination threshold can be set to equal an average or median illumination value of pixels within the pixel matrix 54 having a greater than zero illumination value. Alternatively, the illumination threshold can be set to a value where the illumination of a measurable percentage of pixels is less than or greater than the threshold. For example, the median illumination value of the distribution of illumination of pixels within the pixel matrix 54 can equal the 50th percentile of the distribution of the illumination of pixels within the pixel matrix. Alternatively, the illumination threshold can be set to an illumination value equaling the 20th percentile of the distribution of the illumination of pixels within the pixel matrix 54. In other words, the threshold can be set to an illumination value greater than or equal to the illumination value of the lowest 20 percent of the pixels within the pixel matrix 54. This threshold is also less than or equal to the illumination of the highest 80 percent of the pixels within the pixel matrix 54. Once the pixels residing within the illumination area(s) 84 have been identified, the dimensions of the center location and the minimum perimeter distance of the center location of the illumination area 84 can be determined as discussed.

It should be noted that the aforementioned exemplary embodiments are generally based upon detection of illumination region boundaries designed to identify dark region optical defects. Similar, related or other approaches may be used to identify other optical defects suggestive of optical misalignment, including but not limited to glare regions and blurring regions, which can be caused by, e.g., unintentional light reflection off a surface of the optical tip 106 or viewing head assembly 114 of the remote viewing device 110, or by the presence of glue or epoxy that seeped into the optical path of the remote viewing device prior to curing. Moreover, specialized illumination (e.g., pointing a light source at the end of the insertion tube 112 from outside the field of view) or target objects (e.g., a field of dots that should appear visually crisp and uniform over the entire image) could be used to enable detection of such optical defects. The active display area 80 could then be repositioned, as discussed herein, to eliminate or minimize the visibility of the optical defect(s).

Although various embodiments have been described herein, it is not intended that such embodiments be regarded as limiting the scope of the disclosure, except as and to the extent that they are included in the following claims—that is, the foregoing description is merely illustrative, and it should be understood that variations and modifications can be effected without departing from the scope or spirit of the various embodiments as set forth in the following claims. Moreover, any document(s) mentioned herein are incorporated by reference in its/their entirety, as are any other documents that are referenced within such document(s).

What is claimed is:

1. A method for adapting the operation of an imaging system of a remote viewing device to correct optical misalignment, comprising the steps of:
providing an imaging system, said imaging system comprising:
an imager including a pixel matrix having a plurality of pixels, wherein a subset of said plurality of pixels corresponds to an active display area of said pixel matrix, said active display area having a center location; and
at least one lens through which a field of light passes to form at least one illumination area that overlaps at least a portion of said plurality of pixels;
identifying the presence of at least one optical defect suggestive of optical misalignment; and
repositioning said active display area within said plurality of pixels in response to the presence of said at least one optical defect.

2. The method of claim 1, wherein said at least one optical defect is selected from the group consisting of:
(a) at least one dark region within said pixel matrix;
(b) at least one glare region within said pixel matrix;
(c) at least one blurred region within said pixel matrix;
(d) a combination of (a) and (b);
(e) a combination of (a) and (c);
(e) a combination of (b) and c); and
(f) a combination of (a), (b) and (c).

3. The method of claim 1, wherein pixels within said active display area are displayed on a display monitor.

4. The method of claim 1, wherein said repositioning step is performed by an operator by providing input to said imaging system.

5. The method of claim 1, wherein said identifying step is performed via pattern recognition software, and wherein output from said pattern recognition software is used to perform said repositioning step.

6. The method of claim 1, wherein said field of light forms two illumination areas, each of which is formed by a separate field of light passing through said at least one lens.

7. The method of claim 6, wherein said two illumination areas are at least partially overlapping so as to form an overlap region.

8. The method of claim 7, further comprising the steps of:
identifying a center location of said overlap region;
confirming that said center location of said overlap region is offset from said center location of said active display area; and
wherein said repositioning step is effective to reduce said offset between said center location of said overlap region and said center location of said active display area to an extent whereby said center location of said overlap region is at least substantially proximate said center location of said active display area.

9. A method for adapting the operation of an imaging system of a remote viewing device to compensate for optical misalignment, comprising the steps of:
providing an imaging system, said imaging system comprising:
an imager including a pixel matrix having a plurality of pixels, wherein a subset of said plurality of pixels corresponds to an active display area of said pixel matrix, said active display area having a center location; and
at least one lens through which a field of light passes to form at least one illumination area that overlaps at least a portion of said plurality of pixels;
confirming that at least a portion of said active display area lies outside of said perimeter of said at least one illumination area; and
repositioning said active display area such that said repositioned active display area lies at least substantially entirely within said at least one illumination area.

10. The method of claim 9, further comprising the steps of:
providing a grid that is configured to reflect light that forms a grid image having a center location;
capturing at least a portion of said grid image within said pixel matrix;
confirming that said center location of said grid image is offset from said center location of said active display area; and
wherein said repositioning step is effective to reduce said offset between said center location of said grid image and said center location of said active display area to an extent whereby said center location of said grid image is at least substantially proximate said center location of said active display area.

11. The method of claim 9, wherein said field of light forms two illumination areas, each of which is formed by a separate field of light passing through said at least one lens.

12. The method of claim 11, wherein said two illumination areas are at least partially overlapping so as to form an overlap region.

13. The method of claim 12, further comprising the steps of:
identifying a center location of the overlap region;
confirming that said center location of said overlap region is offset from said center location of said active display area; and
wherein said repositioning step is effective to reduce said offset between said center location of said overlap region and said center location of said active display area to an extent whereby said center location of said overlap region is at least substantially proximate said center location of said active display area.

14. A method for adapting the operation of an imaging system of a remote viewing device to compensate for optical misalignment, comprising the steps of:
providing an imaging system having an optical axis, said imaging system comprising:
an imager including a pixel matrix having a plurality of pixels, wherein a subset of said plurality of pixels corresponds to an active display area of said pixel matrix; and
at least one lens;
providing a target having a predetermined position with respect to said optical axis;
passing light through said at least one lens to produce an image of said target on said imager;
identifying at least one reference location on said target image;
determining that said at least one reference location is offset from a predetermined location within the active display area; and
repositioning said active display area such that said predetermined location is substantially proximate said at least one reference location.

15. The method of claim 14, wherein the target is a grid.

16. An imaging system adapted to a correct optical misalignment between at least one optical lens and an imager of a remote viewing device, comprising:
a pixel matrix on said imaging device, wherein said pixel matrix includes a plurality of pixels, a first subset of which correspond to an active display area having a center location, and wherein said pixel matrix further includes at least one illumination area having a perimeter and being formed by a field of light passing through said at least one optical lens, said at least one illumination area overlapping at least a portion of said plurality of pixels; and
an aligner adapted to reposition the location of said active display area in response to the presence of at least one optical characteristic.

17. The imaging system of claim 16, wherein said at least one optical characteristic is at least one optical defect suggestive of optical misalignment.

18. The imaging system of claim 16, wherein said at least one optical defect is selected from the group consisting of:
(a) at least one dark region within said pixel matrix;
(b) at least one glare region within said pixel matrix;
(c) at least one blurred region within said pixel matrix;
(d) a combination of (a) and (b);
(e) a combination of (a) and (c);
(e) a combination of (b) and c); and
(f) a combination of (a), (b) and (c).

19. The imaging system of claim 16, wherein said at least one optical characteristic is a difference between an actual position of a pattern and a predetermined position of said pattern, wherein said difference is large enough to be suggestive of optical misalignment.

20. The imaging system of claim 16, wherein prior to being repositioned at least a portion of said active display area is located outside of said perimeter of said at least one illumination area, and wherein after being repositioned said active display area is at least substantially entirely located within said perimeter of said at least one illumination area.

21. A remote viewing device that is configured to be electronically adapted to correct optical misalignment, said remote viewing device comprising:
an insertion tube having a distal end that includes a viewing head assembly, wherein the viewing head assembly includes an imaging system comprising:
an imager including a pixel matrix having a plurality of pixels, wherein a subset of said plurality of pixels corresponds to an active display area of said pixel matrix, said active display area having a center location; and
at least one lens through which a field of light passes to form at least one illumination area that overlaps at least a portion of said plurality of pixels;
a digital signal processor adapted to process a communicated image represented by said pixel matrix, said communicated image including at least one optical defect suggestive of optical misalignment; and
an aligner adapted to communicate with and direct said digital signal processor so as to reposition said active display area in response to the presence of said at least one optical defect.
